(19) United States
(12) Patent Application Publication
(10) Pub. No.: US 2010/0083653 A1
(43) Pub. Date: Apr. 8, 2010

(54) Mass Damper

(75) Inventor: Gene Hawkins, Ann Arbor, MI (US)

Correspondence Address: FREUDENBERG-NOK GENERAL PARTNERSHIP;LEGAL DEPARTMENT, 47690 EAST ANCHOR COURT, PLYMOUTH, MI, 48170-2455, US

(73) Assignee: FREUDENBERG-NOK GENERAL PARTNERSHIP, Plymouth, MI (US)

(21) Appl. No.: 12/333,762

(22) Filed: Dec. 12, 2008

Related U.S. Application Data
(60) Provisional application No. 61/102,448, filed on Oct. 3, 2008.

(51) Int. Cl. F02G 1/043; F16F 9/08

(52) U.S. Cl. 60/517; 267/122

(57) ABSTRACT

A counterbalance system for counterbalancing vibrations of a machine, including a housing adapted to be mounted to the machine. A hydraulic chamber is disposed within the housing and has a first and a second diaphragm on opposite sides thereof. A hydraulic fluid is disposed in the hydraulic chamber. A first air chamber is on a first side of the first diaphragm opposite the hydraulic chamber and a second air chamber is disposed on a second side of the second diaphragm opposite the hydraulic chamber. The hydraulic fluid acts as a mass and the diaphragms and air chambers act as a spring and damper of a mass damper system for counterbalancing vibrations of the machine.

### CROSS-REFERENCE TO RELATED APPLICATIONS

This application claims the benefit of U.S. Provisional Application No. 61/102,448, filed on Oct. 3, 2008. The entire disclosure of the above application is incorporated herein by reference.

### FIELD

The present disclosure relates to a mass damper and more particularly to a hydraulic air spring mass damper.

### BACKGROUND

This section provides background information related to the present disclosure which is not necessarily prior art.

A Stirling machine can be a closed-cycle regenerative heat engine with gaseous working fluid. The energy input to the Stirling machine is separate from its working fluid and the fluid is heated and cooled by heat exchangers. The Stirling machine is designed so that the fluid undergoes fluctuations of its pressure and volume which are harnessed to produce useful work. The Stirling machine can be driven by any external heat source heating the hot heat exchanger. Typically this is the burning of some conveniently available fuel but may also be concentrated solar energy, from nuclear energy or geothermal energy. It also requires a cold sink at the cold heat exchanger, this is typically provided by a flow of air or water. A Stirling machine is described as closed-cycle, because of the fact that the working fluid is permanently contained within the machine. It is called regenerative because it uses an additional internal heat exchanger called a regenerator which increases the Stirling machine's thermal efficiency compared to similar but simpler hot air engines.

The Stirling machine is currently exciting interest as the core component of domestic combined heat and power (CHP) units, which could have a significant effect upon worldwide energy consumption. The Stirling machine has been used in small low power applications for nearly two centuries. Stirling engines continue to be used for their ability to provide mechanical or electrical power, heating or cooling in applications wherever a heat source and heat sink are available.

Since the Stirling machine is a closed cycle, it contains a fixed mass of gas called the “working fluid,” most commonly air, hydrogen or helium. In normal operation, the engine is sealed and no gas enters or leaves the engine. No valves are required, unlike other types of piston engines. The Stirling machine, like most heat-engines, cycles through four main processes: cooling, compression, heating and expansion. This is accomplished by moving the gas back and forth between hot and cold heat exchangers, often with a regenerator between the heater and cooler. The hot heat exchanger is in thermal contact with an external heat source, such as a solar concentrator, and the cold heat exchanger being in thermal contact with an external heat sink, such as air fins. A change in gas temperature will cause a corresponding change in gas pressure, while the motion of the piston causes the gas to be alternately expanded and compressed.

The gas follows the behavior described by the gas laws which describe how a gas's pressure, temperature and volume are related. When the gas is heated, because it is in a sealed chamber, the pressure rises and this then acts on the power piston to produce a power stroke. When the gas is cooled the pressure drops and this means that less work needs to be done by the piston to compress the gas on the return stroke, thus yielding a net power output.

To summarize, the Stirling machine uses the temperature difference between its hot end and cold end to establish a cycle of a fixed mass of gas, heated and expanded, and cooled and compressed, thus converting thermal energy into mechanical energy. The mechanical energy can be used to drive a mover of a power module in a reciprocating fashion relative to a stator in order to produce electrical power. The greater the temperature difference between the hot and cold sources, the greater the thermal efficiency.

Nearly all types of machines create undesirable vibrations during operation. For many machines, the vibration involves some form of reciprocating motion within the machine. It is desirable to eliminate vibrations that are created during operation of a Stirling machine. Many devices have been created for reducing, or eliminating, machine vibration.

It is desirable to provide a mass-damper system for a Stirling machine that is relatively low in cost, is relatively light in weight for a particularly sized counterbalance mass, has vibration characteristics that can be easily tuned to a particular machine operating speed, and can be easily mounted onto a Stirling machine.

### SUMMARY

This section provides a general summary of the disclosure, and is not a comprehensive disclosure of its full scope or all of its features.

A hydraulic mass-damper system is provided for counterbalancing vibrations of a Stirling machine including a housing adapted to be mounted to the Stirling machine. A hydraulic chamber is disposed within the housing and includes a first and a second diaphragm on opposite sides thereof. A hydraulic fluid is disposed in the hydraulic chamber. A first air chamber is disposed on a first side of the first diaphragm opposite the hydraulic chamber and a second air chamber is disposed on a second side of the second diaphragm opposite the hydraulic chamber.

According to a further aspect of the present disclosure, the air spring chambers can be divided into a primary and a secondary chamber in communication with the primary chamber via a temperature-controlled orifice.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic view of a Stirling machine with a counterbalance system according to the principles of the present disclosure;

FIG. 2 is a schematic view of an alternate counterbalance system according to the principles of the present disclosure;

FIG. 3 is a schematic view of an alternate counterbalance system having an air spring with a temperature-controlled orifice communicating between primary and secondary air chambers for temperature compensation;

FIGS. 4-6 illustrate an exemplary temperature controlled orifice for use in the counterbalance system of FIG. 3, shown in different operation states;

FIG. 7 is a schematic view of an alternate counterbalance system having an air spring with multiple temperature-controlled orifices communicating between a primary air chamber and multiple secondary air chambers for temperature compensation;

FIG. 8 is a end view illustrating the multiple secondary chambers of FIG. 7; and

FIGS. 9-11 illustrate exemplary temperature controlled orifices for use in the counterbalance system of FIGS. 7 and 8, shown in different operation states.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

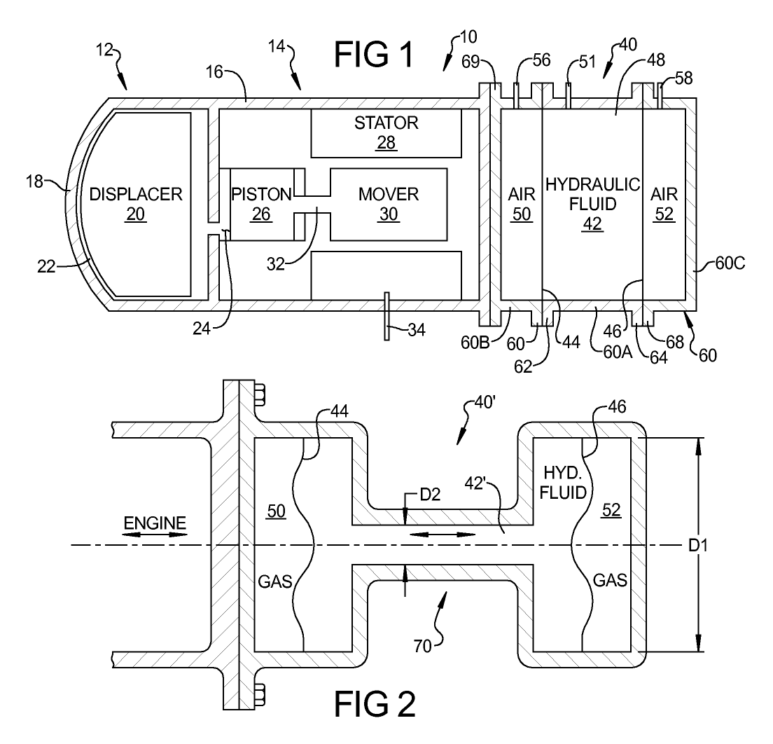

FIG. 1 is a schematic illustration of a Stirling cycle machine 10 that is designed as a power generator. The Stirling cycle machine 10 includes a displacer assembly 12 and a linear alternator 14. The displacer assembly 12 and linear alternator 14 are assembled within a housing 16. The displacer assembly 12 includes a heater head 18 and a displacer piston 20 that reciprocates between a hot space 22 and a cold space 24 in response to thermodynamic heating of the hot space. The hot space is heated from heater head 18 via a heat source such as a solar concentrator, or other heat source. In operation, displacer piston 20 moves working gas between the hot and cold spaces 22, 24.

A power piston 26 reciprocates within linear alternator and is in direct fluid communication with cold space 24 and moves in response to pressure pulse variations within the cold space caused by reciprocation of displacer piston 20. The linear alternator 14 includes a stator 28 and a mover 30. Stator 28 can include an array of stationary laminations that are secured via a plurality of fasteners (not shown) within the housing 16. The stationary laminations form a plurality of spaced apart radially extending stationary outer stator lamination sets defining a plurality of stator polls, winding slots, and magnetic receiving slots. An array of annular shaped magnets are bonded to an inner diameter of stationary laminations for the purpose of producing magnetic flux. Each magnet is received and mounted within the plurality of magnetic receiving slots.

Similarly, mover 30 comprises an array of moving iron laminations that are secured to a shaft 32. Shaft 32 and such laminations move in reciprocating motion along with power piston 26. Relative motion between the moving laminations of mover 30 and the stationary laminations of stator 28 produces electrical power that is output through a power output line 34. Exemplary Stirling cycle machines of the type described herein are disclosed in U.S. Pat. Nos. 5,743,091; 5,895,033; 5,918,463; 5,920,133; and 6,050,092 which are incorporated herein by reference in their entirety. Furthermore, Stirling cycle machines of this type are commercially available from Infinia Corp. of Kennowick, Wash.

A hydraulic air spring mass damper 40 according to the present disclosure, is assembled to the housing 16 in order to counterbalance the vibrations of the Stirling machine 10. The Stirling machine 10 can be designed for continuous operation twenty-four hours per day, seven day per week for many years. Further, known commercial Stirling machines can operate at approximately 60 Hz which results in several billion cycles over the life of the machine. Accordingly, the mass damper system 40 must be very robust. Accordingly, the mass damper 40 according to the present disclosure includes a hydraulic chamber 42 disposed between a first diaphragm 44 and a second diaphragm 46. A hydraulic fluid 48 fills the hydraulic chamber 42. A first air chamber 50 is disposed adjacent the first diaphragm 44 opposite the hydraulic chamber 42. A second air chamber 52 is disposed adjacent to the second diaphragm 46 opposite to the hydraulic chamber 42. The hydraulic chamber 42 can be provided with a fitting 54 that allows filling of the hydraulic chamber 42 with hydraulic fluid 48. The first air chamber 50 can include an air fitting 56 to allow the first air chamber 50 to be charged with air at a predetermined pressure. Similarly, the second air chamber 52 can be provided with an air fitting 58 to allow the second air chamber 52 to be charged with air at a predetermined pressure.

The mass damper 40 can include a housing 60 having a first housing portion 60A surrounding the hydraulic chamber; a first air chamber portion 60B surrounding the first air chamber 50 and a second air chamber portion 60C surrounding the second air chamber 52. The hydraulic fluid chamber portion 60A includes flange portions 62, 64 while first chamber portion 60B includes a corresponding flange portion 66 that engages flange portion 62 and the second air chamber portion 60C includes a flange 68 that engages the flange 64 each for sandwiching the diaphragms 44, 46 therebetween. The housing 60 can include a flange 69 for mounting the housing to the housing 16 of the Stirling machine 10 or can be otherwise mounted to the to the Stirling machine 10 using other known mounting techniques.

In operation, the mass of the hydraulic fluid 48 disposed in the hydraulic chamber 42 between diaphragms 44, 46 acts as a mass disposed between air springs defined by the diaphragms 44, 46 and air chambers 50, 52. The amount of fluid disposed in the hydraulic chamber 42 as well as the air pressure within and dimensions of the first and second air chambers 50, 52 can be tuned to damp the vibrations generated by the Stirling machine 10. As illustrated in FIG. 2, the hydraulic chamber 42′ of the modified mass damper 40′ can be provided with a first diameter D1 adjacent to the first diaphragm 44 and the second diaphragm 46 and can include a reduced diameter central portion 70 having a second diameter D2. The reduced diameter central portion 70 reduces the mass and cost of the mass damper while not impacting the operation of the mass damper 40′.

The diaphragms 44, 46 can be formed from a flexible elastomeric sheet material such as chloroprene, neoprene, or urethane. The diaphragm 44 is clamped between housing sections 60A and 60B and diaphragm 46 is clamped between housing sections 60A and 60C as illustrated in FIG. 1.

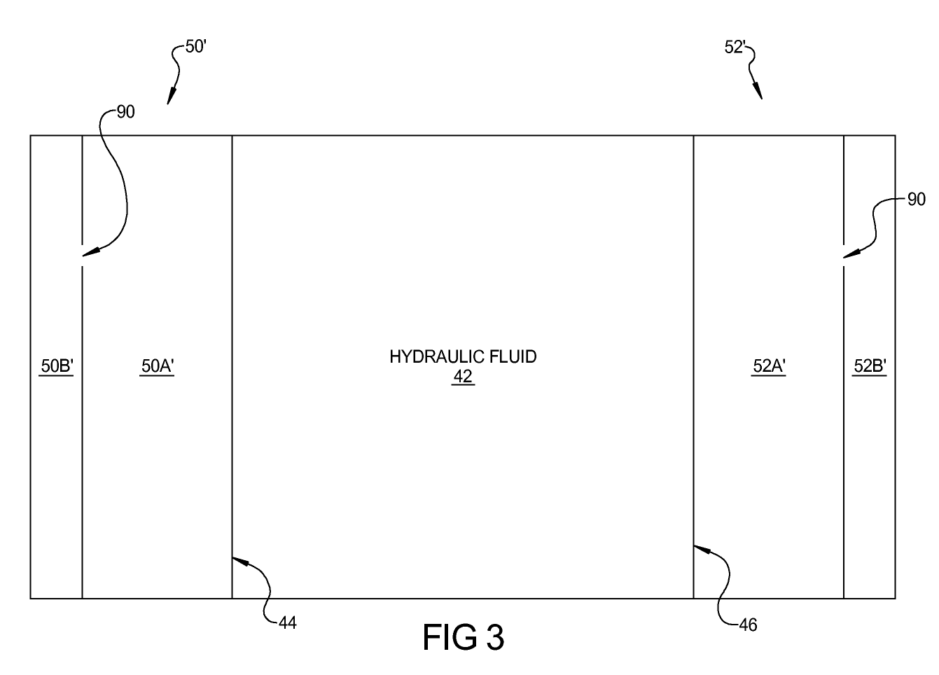

The pressure of the air within first and second air chambers 50, 52 can directly affect the spring rate provided by the air chambers 50, 52. Since the temperature of the air chambers can vary, the pressure within the air chambers 50, 52 can vary with the temperature changes, thus resulting in inconsistent operation of the mass damper 40. Higher pressure air provides a higher spring rate than lower pressure air. In order to accommodate for the pressure changes due to temperature changes, the spring and damper characteristics may need to be altered to provide efficient operation of the mass damper system. Accordingly, as illustrated in FIG. 3, the first air chamber 50′ can be separated into a primary chamber 50A′ and a second chamber 50B′ while the hydraulic chamber 52′ can be separated into a primary chamber 52A′ and a secondary chamber 52B′. The secondary chambers 50B′ and 52B′ can be in communication with the primary chambers 50A′, 52A′ via a temperature controlled orifice 90. The size of the temperature controlled orifice 90 can be varied depending upon a temperature and/or pressure within the chambers 50′, 52′. In particular, as the temperature of the chambers 50′, 52′ changes, the pressure within the chamber also increases with the temperature increase. This pressure change can impact the operation of the air spring. Accordingly, the temperature controlled orifice 90 is controlled to account for temperature/pressure differences and can be varied in order to provide a damping effect as needed for efficient operation of the mass damper 40. It should be noted that numerous techniques can be employed for varying the size of the temperature controlled orifice 90 disposed between the primary chambers 50A, 52A′ and the secondary chambers 50B′ and 52B′.

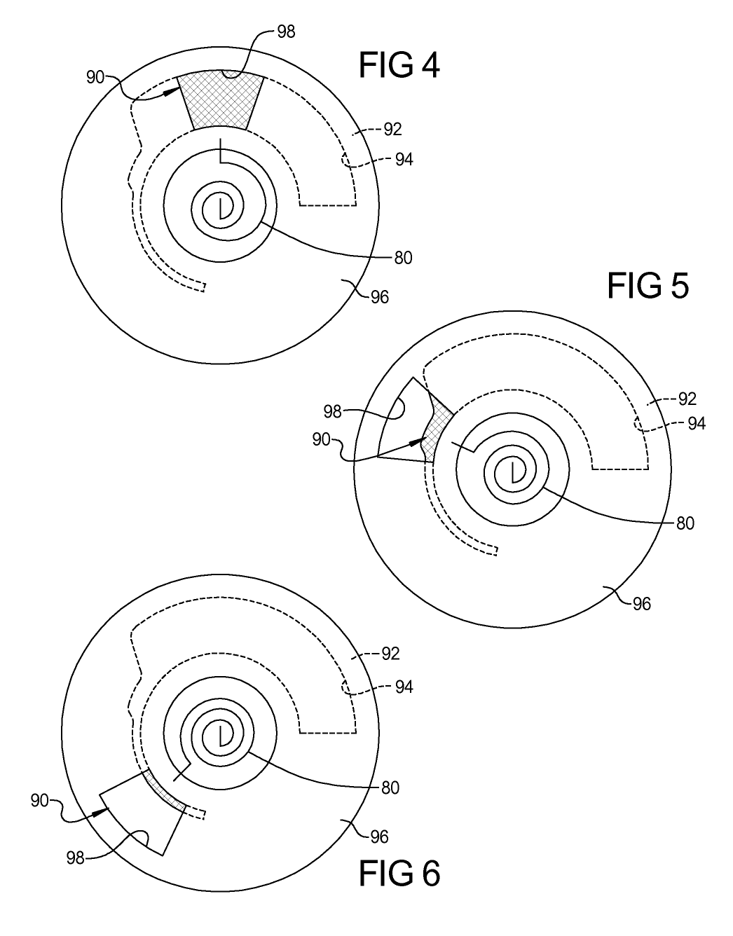

By way of non-limiting example, FIGS. 4-6 illustrate a partition plate 92 having an orifice 94 and an overlapping shutter plate 96 having a orifice 98 which can overlap the orifice 94 in a controlled manner to vary the area of the temperature controlled orifice 90. A bi-metallic spring 80 can be employed for varying the position of the shutter plate 96 relative to the partition plate 92 based upon the temperature within the chambers 50, 52. As the temperature within the chambers increases, the length of the torsion spring 80 varies, thus adjusting the position of the shutter plate 96 relative to the orifice partition plate 92. As shown in FIG. 4, the orifice 90 is shown in the fully opened position for higher temperature operation; as shown in FIG. 5, the orifice is in a partially open position for medium temperature operation; and as shown in FIG. 6, the orifice is in a generally closed position for lower temperature operation. It is noted that the opening 94 can be designed in order to provide the appropriate opening amount for various temperature conditions.

It should be noted that alternative devices can be utilized for varying the orifice size 90. In particular, a control system can be utilized along with a temperature sensor and various mechanical or electrical-mechanical devices for actuating a shutter for partially closing the orifice dependent upon a sensed temperature condition within the air chambers 50′, 52′. It is noted that exemplary control devices for controlling the opening of the orifice can include various bimetallic springs (torsional, leaf, or other), electronically controlled motors, such as stepper motors, separate air chamber with piston, or other devices which can cause motion as a function of temperature.

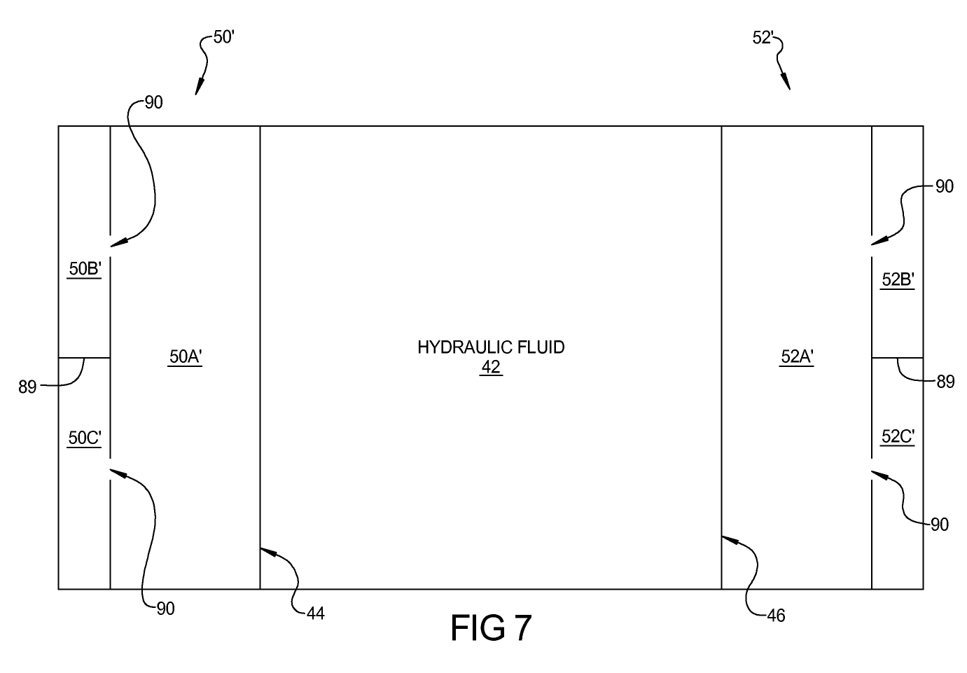

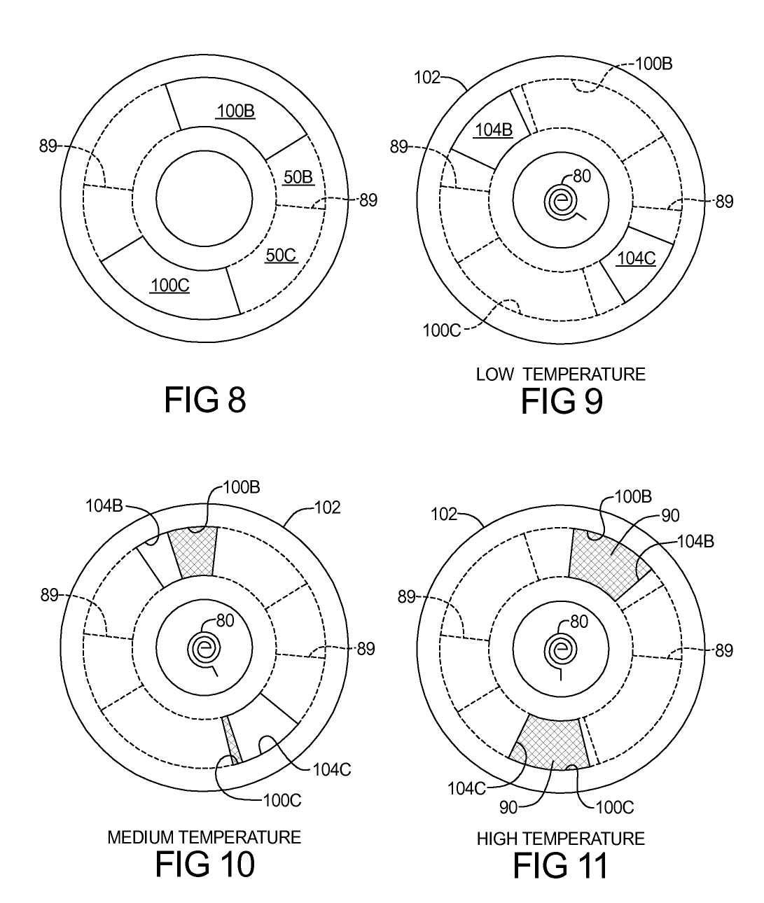

Furthermore, it should be understood that the air chambers 50″, 52″ can be further subdivided by partitions 89 into multiple secondary chambers 50B, 50C and 52B, 52C, as illustrated in FIG. 7 and having corresponding temperature controlled orifices 90 for controlling the spring rate and damping effect of the air chambers due to temperature/pressure changes. FIG. 8 illustrates the two secondary chambers 50B, 50C each defining a semi-cylindrical space that can be equal to one another in volume or can be different from one another. Each of the secondary chambers 50B, 50C can include a chamber opening 100B, 100C, respectively. As shown in FIGS. 9-11, a throttle plate 102 can be provide adjacent to the chamber openings 100B, 100C and can include throttle plate openings 104B, 104C associated with chamber openings 100B, 100C, respectively. The rotational position of the throttle plate 102 can be altered by a temperature responsive bi-metallic spring 106 or by another alternative control system. In a low temperature operation as illustrated in FIG. 9, the throttle plate is positioned so as to close off the chamber openings 100B, 100C to effectively reduce the volume of the air chamber. In a medium temperature operation as shown in FIG. 10, the throttle plate 102 is rotated in a clockwise direction as illustrated to partially uncover the chamber opening 100B by a certain amount and to partially uncover the chamber opening 100C to a lesser extent. In a high temperature operation as shown in FIG. 11, the throttle plate 102 is further rotated by the bi-metallic spring 80 in a clockwise direction to fully align the throttle plate openings with the chamber openings to allow maximum communication between the primary chamber 50A and the secondary chambers 50B, 50C, effectively increasing the volume of the air spring and reducing the damping effect created by the temperature controlled orifices 90.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. A counterbalance system for counterbalancing vibrations of a machine, comprising:
a housing adapted to be mounted to the machine;
a hydraulic chamber disposed within said housing and having a first and a second diaphragm on opposite sides thereof;
a hydraulic fluid disposed in said hydraulic chamber;
a first air chamber on a first side of said first diaphragm opposite said hydraulic chamber; and
a second air chamber on a second side of said second diaphragm opposite said hydraulic chamber.

2. The counterbalance system according to claim 1, wherein said hydraulic chamber has a first diameter adjacent to said first diaphragm and said second diaphragm and a reduced diameter central portion.

3. The counterbalance system according to claim 1, wherein said first air chamber includes a first primary chamber disposed adjacent to said first diaphragm and a first secondary chamber in communication with said first primary chamber via a first temperature controlled orifice.

4. The counterbalance system according to claim 3, wherein said second air chamber includes a second primary chamber disposed adjacent to said second diaphragm and a second secondary chamber in communication with said second primary chamber via a second temperature controlled orifice.

5. The counterbalance system according to claim 3, wherein said first temperature controlled orifice includes means for adjusting a size of said first temperature controlled orifice based upon a temperature inside of said first air chamber.

6. The counterbalance system according to claim 4, wherein said second temperature controlled orifice includes means for adjusting a size of said second temperature controlled orifice based upon a temperature inside of said second air chamber.

7. The counterbalance system according to claim 3, wherein said first temperature controlled orifice includes a first wall having a first orifice therein and a shutter adjacent to said first wall and movable relative to said first orifice for blocking a portion of said first orifice based upon a temperature inside of said first air chamber.

8. The counterbalance system according to claim 7, wherein said shutter is attached to a bi-metallic spring for adjusting a position of said shutter based upon a temperature of said first air chamber.

9. The counterbalance system according to claim 7, wherein said shutter is attached to an actuator mechanism for adjusting a position of said shutter based upon a temperature of said first air chamber.

10. The counterbalance system according to claim 4, wherein said second temperature controlled orifice includes a first wall having a first orifice therein and a shutter adjacent to said first wall and movable relative to said first orifice for blocking a portion of said first orifice based upon a temperature inside of said second air chamber.

11. The counterbalance system according to claim 10, wherein said shutter is attached to a bi-metallic spring for adjusting a position of said shutter based upon a temperature of said second air chamber.

12. The counterbalance system according to claim 10, wherein said shutter is attached to an actuator mechanism for adjusting a position of said shutter based upon a temperature of said second air chamber.

13. The counterbalance system according to claim 1, wherein said first air chamber includes a primary chamber disposed adjacent to said first diaphragm and a plurality of secondary chambers each in communication with said first primary chamber via a temperature controlled orifice.

14. A machine, comprising:
a Stirling machine; and
a mass damper system including a housing mounted to said Stirling machine, including;
a hydraulic chamber disposed within said housing and having a first and a second diaphragm on opposite sides thereof;
a hydraulic fluid disposed in said hydraulic chamber;
a first air chamber on a first side of said first diaphragm opposite said hydraulic chamber; and
a second air chamber on a second side of said second diaphragm opposite said hydraulic chamber.

15. The machine according to claim 14, wherein said hydraulic chamber has a first diameter adjacent to said first diaphragm and said second diaphragm and a reduced diameter central portion.

16. The machine according to claim 14, wherein said first air chamber includes a first primary chamber disposed adjacent to said first diaphragm and a first secondary chamber in communication with said first primary chamber via a first temperature controlled orifice.

17. The machine according to claim 16, wherein said second air chamber includes a second primary chamber disposed adjacent to said second diaphragm and a second secondary chamber in communication with said second primary chamber via a second temperature controlled orifice.

18. The machine according to claim 16, wherein said first temperature controlled orifice includes means for adjusting a size of said first temperature controlled orifice based upon a temperature inside of said first air chamber.

19. The machine according to claim 17, wherein said second temperature controlled orifice includes means for adjusting a size of said second temperature controlled orifice based upon a temperature inside of said second air chamber.

20. The machine according to claim 16, wherein said first temperature controlled orifice includes a first wall having a first orifice therein and a shutter adjacent to said first wall and movable relative to said first orifice for blocking a portion of said first orifice based upon a temperature inside of said first air chamber.

21. The machine according to claim 20, wherein said shutter is attached to a bi-metallic spring for adjusting a position of said shutter based upon a temperature of said first air chamber.

22. The machine according to claim 20, wherein said shutter is attached to an actuator mechanism for adjusting a position of said shutter based upon a temperature of said first air chamber.

23. The machine according to claim 17, wherein said second temperature controlled orifice includes a first wall having a first orifice therein and a shutter adjacent to said first wall and movable relative to said first orifice for blocking a portion of said first orifice based upon a temperature inside of said second air chamber.

24. The machine according to claim 23, wherein said shutter is attached to a bi-metallic spring for adjusting a position of said shutter based upon a temperature of said second air chamber.

25. The machine according to claim 23, wherein said shutter is attached to an actuator mechanism for adjusting a position of said shutter based upon a temperature of said second air chamber.

26. The machine according to claim 14, wherein said first air chamber includes a primary chamber disposed adjacent to said first diaphragm and a plurality of secondary chambers each in communication with said first primary chamber via a temperature controlled orifice.
